(19) United States
(12) Patent Application Publication
(10) Pub. No.: US 2008/0279740 A1
(43) Pub. Date: Nov. 13, 2008

(54) DeNOx catalyst preparation method

(76) Inventors: Steven M. Augustine, Ellicott City, MD (US); Guoyi Fu, Ellicott City, MD (US)

Correspondence Address: KING & SPALDING LLP, 1180 PEACHTREE STREET, ATLANTA, GA, 30309-3521, US

(21) Appl. No.: 11/803,113

(22) Filed: May 11, 2007

(51) Int. Cl. B01D 53/56; B01J 21/06

(52) U.S. Cl. 423/239.1; 502/304; 502/338

(57) ABSTRACT

A catalyst comprising iron and a titanium-zirconium mixed oxide gel, and a process for preparing the catalyst are disclosed. The process comprises combining an iron compound and a titanium-zirconium mixed oxide gel in water to form an iron-titanium-zirconium mixed oxide, and then removing water to produce the catalyst. The catalyst is particularly effective for DeNOₓ applications, demonstrating high activity and good thermal stability.

### FIELD OF THE INVENTION

This invention relates to a catalyst and a process to produce the catalyst. The catalysts are useful for purifying exhaust gases and waste gases from combustion processes.

### BACKGROUND OF THE INVENTION

The high temperature combustion of fossil fuels or coal in the presence of oxygen leads to the production of unwanted nitrogen oxides (NOₓ). Significant research and commercial efforts have sought to prevent the production of these well-known pollutants, or to remove these materials prior to their release into the air. Additionally, federal legislation has imposed increasingly more stringent requirements to reduce the amount of nitrogen oxides released to the atmosphere.

Processes for the removal of NOₓ from combustion exit gases are well known in the art. The selective catalytic reduction process is particularly effective. In this process, nitrogen oxides are reduced by ammonia (or another reducing agent such as unburned hydrocarbons present in the waste gas effluent) in the presence of a catalyst with the formation of nitrogen. Effective selective catalytic reduction (SCR) DeNOₓ catalysts include a variety of mixed metal oxide catalysts, including vanadium oxide supported on an anatase form of titanium dioxide (see, for example, U.S. Pat. No. 4,048,112) and titania and at least one oxide of molybdenum, tungsten, iron, vanadium, nickel, cobalt, copper, chromium or uranium (see, for example, U.S. Pat. No. 4,085,193).

A particularly effective catalyst for the selective catalytic reduction of NOₓ is a metal oxide catalyst comprising titanium dioxide, divanadium pentoxide, and tungsten trioxide and/or molybdenum trioxide (U.S. Pat. No. 3,279,884). U.S. Pat. Appl. Pub. No. 2006/0084569 teaches a method of producing a catalyst comprised of titanium dioxide, vanadium oxide and a supported metal oxide. The supported metal oxide (one or more of W, Mo, Cr, Sc, Y, La, Zr, Hf, Nb, Ta, Fe, Ru, and Mn) is first supported on the titanium dioxide prior to depositing vanadium oxide. The titania supported metal oxide has an isoelectric point of less than or equal to a pH of 3.75 prior to depositing the vanadium oxide.

Another advantage of vanadium and tungsten oxides supported on titania is that they have a low activity for oxidation of sulfur dioxide (SO₂) to sulfur trioxide (SO₃). Since sulfur is often present in significant quantities in combustion fuels such as coal, it is necessary to suppress the formation of SO₃ which contributes to acid rain and other environmental hazards.

Despite these advantages, it would be advantageous to replace tungsten and/or vanadium with alternative metal components due to the significant drawbacks with using both tungsten and vanadium in SCR catalysts. First, tungsten shortages have lead to increased costs associated with its use. Second, the potential toxicity of vanadium oxide has lead to health concerns as well as significant costs associated with disposal of spent catalysts.

It is known in the art that iron supported on titanium dioxide is an effective selective catalytic reduction DeNOₓ catalyst (see, for example, U.S. Pat. No. 4,085,193). However, the limitations to using iron as an alternative are its lower relative activity and, by comparison, a high rate of oxidation of sulfur dioxide to sulfur trioxide (see, for example, Canadian Pat. No. 2,496,861).

In sum, new catalysts and new catalyst preparation methods are required for the development of improved selective catalytic reduction processes to remove nitrogen oxides prior to their release into the atmosphere. Catalysts which do not contain vanadium and/or tungsten are particularly desirable.

### SUMMARY OF THE INVENTION

The invention is a catalyst that is useful in the DeNOₓ process and a process for preparing the catalyst. The catalyst comprises iron and a titanium-zirconium mixed oxide gel. The process comprises combining an iron compound and a titanium-zirconium mixed oxide gel in water to form an iron-titanium-zirconium mixed oxide, and then removing water to produce the catalyst. The catalyst demonstrates high NO conversion, reduced activity for SOₓ oxidation, and improved thermal stability.

### DETAILED DESCRIPTION OF THE INVENTION

The catalyst of the invention comprises iron and a titanium-zirconium mixed oxide gel. Titanium-zirconium mixed oxide gels are well known in the art, and are detailed below.

The catalyst preferably contains from 0.25 to 10 weight percent iron, and more preferably, from 0.5 to 6 weight percent iron, based upon the total weight of the catalyst. Preferably, the catalyst may also comprise cerium. Preferably, the catalyst contains from 0.1 to 4 weight percent cerium, more preferably from 0.25 to 1 weight percent cerium.

The catalyst of the invention preferably exhibits increased thermal stability. Preferably, the catalyst has a surface area greater than 50 m²/g after being calcined at 700° C. for 6 hours.

The process of the invention comprises first combining an iron compound and a titanium-zirconium mixed oxide gel in water to form a mixed oxide. Suitable iron compounds are any iron-containing substance that is soluble in water. Illustrative iron compounds useful in the invention include, but are not limited to, iron halides, iron nitrates, iron sulfates, iron acetates, and hydrates thereof. For example, FeCl₃, FeBr₃, Fe(NO₃)₃, Fe₂(SO₄)₃, Fe(SO₄), Fe(C₂H₃O₂)₂, Fe₂(C₂O₄)₃, and hydrates thereof may be used.

Titanium-zirconium mixed oxide gels are well known in the art. The titanium-zirconium mixed oxide gel contemplated in this invention is an inorganic gel formed by the co-precipitation of the oxides of titanium and zirconium. The gel can be prepared by employing any of the well known techniques of the prior art, see, e.g., U.S. Pat. Nos. 5,021,392 and 6,391,276.

In a typical process, a titanium precursor and a zirconium precursor are mixed in water (or a solvent that contains water) to form a clear solution. The pH of the solution is then raised by the addition of a base to precipitate a titanium-zirconium mixed oxide polycondensate. During this process, the titanium and zirconium precursors are hydrolyzed to form hydroxylated titanium and zirconium species. Next, condensation occurs between the hydroxylated species forming a colloidal mixture known as a sol having alternating Ti—O—Zr—O— bonds. Finally, polycondensation between these colloidal sols and additional networking eventually results in a three dimensional network. The hydrolysis, condensation, and polycondensation steps may take place more or less simultaneously rather than sequentially.

After formation, the polycondensate is typically aged for a period of time, typically 0.25 to 12 hours, at the elevated pH. The polycondensate is washed, filtered, and dried to form the titanium-zirconium mixed oxide gel. The gel is not calcined prior to combining with the iron compound.

Suitable titanium precursors for use in gel preparation include any titanium-containing substance capable of being incorporated into the gel. Illustrative titanium precursors include, but are not limited to, titanium halides, titanium oxyhalides, titanium oxysulfates, titanium alkoxides, titanium acetates, and titanium acetylacetonates. For example, titanium tetrachloride, titanium oxydichloride, titanium acetate, titanium acetylacetonate, and titanium tetraethoxide may be used.

Suitable zirconium precursors for use in gel preparation include any zirconium-containing substance capable of being incorporated into the gel. Illustrative zirconium precursors include, but are not limited to, zirconium halides, zirconium oxyhalides, zirconium oxysulfates, zirconium alkoxides, zirconium acetates, and zirconium acetylacetonates. For example, zirconium tetrachloride, zirconium oxydichloride, zirconium acetate, zirconium acetylacetonate, and zirconium tetraethoxide may be used.

The hydrolysis and polycondensation may be catalyzed by an acid, such as hydrochloric acid, sulfuric acid, nitric acid, and the like, at elevated temperatures. Typically, the hydrolysis and polycondensation reactions are catalyzed by the addition of a base. Suitable bases include ammonium hydroxide, tetraalkyl ammonium hydroxides, alkali metal hydroxides, or alkaline earth metal hydroxides. Water is required to achieve hydrolysis. Although water by itself is preferred, a solvent such as alcohol in combination with water may also be used.

Once the titanium-zirconium mixed oxide polycondensate has been formed, the gel is preferably isolated by filtration, decantation, centrifugation or similar mechanical means from any free liquid which may be present and then, if so desired, washed with a suitable solvent such as water, a lower aliphatic alcohol or ketone or the like, and then dried. The drying is typically conducted at low temperature, e.g., less than 150° C., and may also be conducted under vacuum.

The ratio of Ti:Zr in the titanium-zirconium mixed oxide gel is preferably in the range of from 1:1 to 20:1, more preferably in the range of from 3:1 to 10:1, and most preferably in the range of from 4:1 to 9:1.

The process of the invention comprises combining the iron compound and the titanium-zirconium mixed oxide gel in water to form an iron-titanium-zirconium mixed oxide.

The combination of the iron compound and the titanium-zirconium mixed oxide gel may be performed using any suitable addition or mixing method. The order of adding the individual components of the slurry is not critical. For example, the iron compound may be added to the water first, followed by addition of the titanium-zirconium mixed oxide gel. Alternatively, the titanium-zirconium mixed oxide gel may be added to the water, followed by the iron compound; or the titanium-zirconium mixed oxide gel and the iron compound may be added simultaneously to the water; or the water may be added to the other two components. The temperature and pressure of the combination are not considered critical, but preferably the combining is performed at a temperature below 100° C. and at atmospheric pressure.

Preferably, a cerium compound is combined with the iron compound and the titanium-zirconium mixed oxide gel in water. Suitable cerium compounds are any cerium-containing substance that is soluble in water. Suitable cerium compounds include, but are not limited to, cerium halides, cerium alkoxides, cerium acetate, and cerium acetylacetonate. Preferably, the amount of cerium is added such that the catalyst contains from 0.1 to 4 weight percent cerium, more preferably from 0.25 to 1 weight percent cerium.

Following the combination, the iron compound is deposited on the surface of the titanium-zirconium mixed oxide gel to produce an iron-titanium-zirconium mixed oxide species.

Following formation of the iron-titanium-zirconium mixed oxide, the gel is preferably isolated by filtration, decantation, centrifugation or similar mechanical means from any free water which may be present and then, if so desired, washed with a suitable solvent such as water, a lower aliphatic alcohol or ketone or the like, and then dried. The drying is typically conducted at low temperature, e.g., less than 150° C., and may also be conducted under vacuum.

Preferably, following isolation from any free water, the catalyst is calcined by heating at a temperature of at least 250° C. More preferably, the calcination temperature is at least 300° C. but not greater than 1000° C. Calcination may be performed in the presence of oxygen (from air, for example) or an inert gas which is substantially free of oxygen such as nitrogen, argon, neon, helium or the like or mixture thereof. Optionally, the calcination may be performed in the presence of a reducing gas, such as carbon monoxide. Typically, calcination times of from about 0.5 to 24 hours will be sufficient.

The catalyst preferably contains from 0.25 to 10 weight percent iron, and more preferably, from 0.5 to 6 weight percent iron, based upon the total weight of the catalyst.

The catalyst produced by the process of the invention exhibits increased thermal stability. Preferably, the catalyst has a surface area greater than 50 m²/g after being calcined at 700° C. for 6 hours.

The catalysts of the invention, and the catalysts produced by the process of the invention, are particularly useful in DeNOₓ applications. The DeNOₓ application comprises contacting a waste stream containing nitrogen oxides with the catalyst to reduce the amount of nitrogen oxides in the waste stream. Preferably, the DeNOₓ process using the catalyst of the invention results in greater then 50 percent reduction in the amount of nitrogen oxides in the waste stream. Such applications are well known in the art. In this process, nitrogen oxides are reduced by ammonia (or another reducing agent such as unburned hydrocarbons present in the waste gas effluent) in the presence of the catalyst with the formation of nitrogen. See, for example, U.S. Pat. Nos. 3,279,884, 4,048,112 and 4,085,193, the teachings of which are incorporated herein by reference.

The following examples merely illustrate the invention. Those skilled in the art will recognize many variations that are within the spirit of the invention and scope of the claims.

### COMPARATIVE EXAMPLE 1

### Conventional Catalyst Preparation

Comparative Catalyst 1 (W—V/TiO₂):Monoethanolamine (0.103 g), deionized water (20 mL), and vanadium pentoxide (0.051 g) are mixed at 80° C. in a 25 mL flask until the vanadium pentoxide dissolves. Then, 10 wt. % tungsten oxide supported on anatase titanium dioxide (10 g, DT 52 from Millennium Inorganic Chemicals, Inc.) is stirred in the solution. The solvent is evaporated under vacuum, and the powder is dried at 110° C. overnight. The dried sample is calcined in air at 600° C. for 6 hours to produce Comparative Catalyst 1. The catalyst contains approximately 0.5 wt. % V₂O₅.

### COMPARATIVE EXAMPLE 2

### Iron Supported on Anatase

Comparative Catalyst 2A (Fe/TiO₂): A 1 wt. % Fe on titania catalyst is prepared by dissolving Fe(SO₄)*7H₂O (1.0 g, from Sigma-Aldrich) in water (40 mL). Then, anatase titanium dioxide (20 g, DT51 from Millennium Inorganic Chemicals, Inc.) is stirred in the solution. The solvent is evaporated under vacuum, and the powder is dried at 110° C. overnight. The dried sample is calcined at 500° C. for 6 hrs.

Comparative Catalyst 2B (Fe—Zr/TiO₂): A solution is prepared by dissolving ZrOCl₂*8H₂O (0.27 g) in water (20 mL). DT51 (10 g) is stirred into the solution and the pH is increased to 8.0 using ammonium hydroxide. The water is removed using vacuum, and the Zr/TiO₂ solid is dried at 100° C. overnight. Next, a solution is prepared by dissolving 0.5 g of iron(II)sulfate (0.5 g) in water (20 mL), and the Zr/TiO₂ solid is stirred into the solution and the pH is lowered to 0.75 with concentrated sulfuric acid. The temperature of the slurry is raised to 80° C. and the water is removed with vacuum. The powder is dried at 110° C. overnight and is calcined at 500° C. for 5 hrs.

Comparative Catalyst 2C (Fe—Ce—Zr/TiO₂): A solution is prepared by combining ZrOCl₂*8H₂O (0.59 g) and (NH₄)₂Ce(NO₃)₆ (1.0 g) with water (40 mL). DT51 (20 g) is added to the solution and mixed as the pH is increased to 8.0. The mixture is filtered, re-slurried in clean deionized water and filtered again. The Ce—Zr/TiO₂ solid is dried overnight at 110° C. and calcined at 500° C. for 6 hrs. Next, a solution is prepared by dissolving iron(II)sulfate (0.5 g) in water (20 mL), and the Ce—Zr/TiO₂ solid is added to this solution, and the water is removed by vacuum. The solid is then dried at 110° C. overnight and calcined at 500° C. for 6 hrs.

Comparative Catalyst 2D (4.5 wt. % Fe/TiO₂): Catalyst 2D is prepared by dissolving Fe(SO₄)*7H₂O (4.5 g) in water (40 mL). Then, anatase titanium dioxide (20 g, DT51) is stirred in the solution. The solvent is evaporated under vacuum, and the powder is dried at 110° C. overnight. The dried sample is calcined at 500° C. for 6 hrs.

### EXAMPLE 3

### Iron Supported on Titanium-Zirconium Mixed Oxide Gels

Catalyst 3A: The Ti—Zr mixed oxide gel is prepared by a co-precipitation process in which the titanium and zirconium precursor solutions are mixed in an 85/15 molar ratio prior to precipitation. The zirconium precursor solution is prepared by dissolving zirconium basic carbonate (235 g) in 50% nitric acid (1000 mL) with stirring and heat. Titanium oxysulfate solution (993 g, 7.9 wt. % TiO₂ solution, Millennium Inorganic Chemicals) is added to the prepared zirconium solution (219 g), and thoroughly mixed, to create the 85/15 molar ratio mixture solution.

In a 3-L round bottom flask equipped with a overhead stirrer and a pH probe attached to a pH controller, deionized water (300 mL) is added, then the titanium-zirconium precursor solution is pumped into the flask through one pump set at a flow rate of 20 mL/min while concentrated ammonium hydroxide is pumped through a second pump controlled by the pH controller and set at a rate to keep the pH at 9.0+/−0.1 during the addition. When the addition is complete, the mixed oxide precipitate in the flask is allowed to age at pH 9 for 30 minutes. After the precipitation is complete, the precipitate is filter washed several times until the conductivity of the filtrate becomes 1 mS/cm or lower. The washed Ti—Zr gel is dried at 110° C. over night.

A solution is prepared by dissolving iron(II)sulfate (3.0 g) in water (20 mL), and the Ti—Zr gel (10 g) is mixed into the solution. The mixture is warmed to 90° C., stirred for 1 hour, and then filtered. The solid is dried at 110° C. overnight, and then calcined at 500° C. for 6 hours. The final catalyst loading is 4.57 wt. % iron.

Catalyst 3B: Catalyst 3B is prepared in the same manner as that of Catalyst 3A, with the exception that oxychloride salts of Ti and Zr are used in precipitation. Zirconium oxychloride octahydrate (56.1 g) is dissolved in about deionized water (200 mL). The titanium oxychloride solution (314.8 g of a solution containing 24.9% TiO₂) is added to the zirconium solution with stirring to make the mixture precursor solution. The final catalyst loading is 4.65 wt. % iron.

### EXAMPLE 4

### Reactor Tests

NO Conversion Test

NO conversion is determined using a powder sample in a fixed bed reactor. The composition of the reactor feed is 800 ppm NO, 1000 ppm NH₃, 3% O₂, 2.5% H₂O, and balance He, and gas hourly space velocity (GHSV) is 79,000 h⁻¹. Catalyst performance is measured using a quadrupole mass spectrometer while the temperature is ramped from 200° C. to 375° C. at 10° C./min. The temperature is maintained at 375° C. for 10 minutes and then cooled to 200° C. at 10° C./min. After holding at 200° C. for 10 minutes the ramp to 375° C. is repeated. Data are collected continuously during the three ramps at an interval of every 5 seconds and are fitted with an Arrhenius approximation to determine conversion at 325° C., which is listed in the tables.

SO₂ Oxidation Test

SO₂ oxidation is determined using a powder sample in a second fixed bed reactor. The composition of the reactor feed is 0.15% SO₂, 20% O₂ and balance nitrogen, and GHSV of 9,400/hr. Measurements are made at 450° C. in 30 minute intervals by first establishing steady state while passing the effluent stream through the reactor to determine the catalyst performance, and then bypassing the reactor to determine concentration measurements in the absence of reaction. Conversion is determined by the relative difference. Data reported in the table are for measurements made at 450° C. and 5 hrs time on stream.

The results, in Table 1, show the catalysts produced by the process of the invention are active for the destruction of nitrogen oxide by ammonia and have improved thermal stability against thermal sintering as demonstrated by high surface area after 700° C. and 800° C. calcination. The results also show the catalysts produced by the process of the invention demonstrate significantly lower SO₂ oxidation activity relative to the comparative example. Undesirable SO₂ oxidation may occur during the removal of NOₓ from combustion exit gases that are formed by the burning of fuels or coal that contain higher contents of sulfur. SOₓ oxidation is of little concern regarding diesel fuels and other fuels having low sulfur content.

TABLE 1
NO Conversion, SO₂ Oxidation, and Surface Area Results

| | | BET surface | BET surface | | |
|---|---|---|---|---|---|
| | | area (after | area (after | | |
| | Fe loading | 700° C. | 800° C. | NOₓ Conversion | SOₓ Oxidation |
| Catalyst # | (wt. %) | calcination) | calcination) | (at 325° C.) | (at 450° C.) |
| 1* | — | 43.4 | 16.9 | 61.8 | |
| 2A* | 1 | 23 | 3.0 | 58.0 | |
| 2B* | 1 | | | 65.4 | |
| 2C* | 1 | | | 68.6 | |
| 2D* | 4.5 | | | 79.4 | 53.4 |
| 3A | 4.57 | 55.5 | 35.2 | 85.9 | 24.2 |
| 3B | 4.65 | 54.2 | 32.5 | 86.9 | 29.0 |

*Comparative Example

We claim:

1. A catalyst comprising iron and a titanium-zirconium mixed oxide gel.

2. The catalyst of claim 1 comprising 0.25 to 10 weight percent iron.

3. The catalyst of claim 1 further comprising cerium.

4. The catalyst of claim 3 comprising 0.1 to 4 weight percent cerium.

5. The catalyst of claim 1 having a surface area greater than 50 m²/g after being calcined at 700° C. for 6 hours.

6. A process for preparing a catalyst comprising:
(a) combining an iron compound and a titanium-zirconium mixed oxide gel in water to form an iron-titanium-zirconium mixed oxide; and
(b) removing water from the iron-titanium-zirconium mixed oxide to produce the catalyst.

7. The process of claim 6 further comprising calcining the iron-titanium-zirconium mixed oxide at a temperature of at least 250° C. following step (b).

8. The process of claim 6 wherein the iron compound is selected from the group consisting of iron halides, iron nitrates, iron sulfates, iron acetates, and hydrates thereof.

9. The process of claim 6 wherein the titanium-zirconium mixed oxide gel is produced by the co-precipitation of a titanium precursor and a zirconium precursor in the presence of water and a base.

10. The process of claim 6 wherein the catalyst has a surface area greater than 50 m²/g after being calcined at 700° C. for 6 hours.

11. The process of claim 6 wherein the catalyst comprises 0.25 to 10 weight percent iron.

12. The process of claim 6 wherein the iron compound and a cerium compound are combined with the titanium-zirconium mixed oxide gel.

13. The process of claim 12 wherein the cerium compound is selected from the group consisting of cerium halides, cerium alkoxides, cerium acetate, and cerium acetylacetonate.

14. A process comprising contacting a waste stream containing nitrogen oxides with the catalyst of claim 1 to reduce the amount of nitrogen oxides in the waste stream.
